(19) United States
(12) Patent Application Publication
(10) Pub. No.: US 2023/0166911 A1
(43) Pub. Date: Jun. 1, 2023

(54) DISPENSER WITH DRAWERS AND SILOS FOR SMALL PACKETS

(71) Applicant: ARTITALIA GROUP, Montreal (CA)

(72) Inventors: Antonio VARDARO, Montreal (CA); Enzo VARDARO, Montreal (CA)

(21) Appl. No.: 18/072,142

(22) Filed: Nov. 30, 2022

Related U.S. Application Data
(60) Provisional application No. 63/284,162, filed on Nov. 30, 2021.

(51) Int. Cl. B65G 1/08

(52) U.S. Cl. CPC B65G 1/08

(57) ABSTRACT

A dispenser for small packets comprises a housing having a cabinet and a chute positioned beneath the cabinet for dispensing small packets. At least one pair of drawers is slidably mounted within the cabinet. Each of these drawers has respective front sides positioned at the cabinet front side and respective interfacing lateral dispensing sides defining a common drop channel therebetween leading the chute. The drawers slidably movable outwardly and inwardly of the cabinet via the cabinet front face. Each of the interfacing lateral dispensing sides has at least one silo structure mounted thereof. Each silo structure comprises a storage compartment for storing small packets and an ejection device for ejecting the small packets into the drop channel.

### CROSS-REFERENCE TO RELATED APPLICATIONS

The present application claims priority on U.S. Provisional Patent Application Ser. No. 63/284,162 filed on Nov. 30, 2021 and incorporated herein by reference in its entirety.

### TECHNICAL FIELD

The present disclosure relates to a dispenser. More specifically but not exclusively, the disclosure relates to a dispenser with drawers and silos for small packets.

### BACKGROUND

Known dispensers for small packets such as cigarettes and other items include housing such as a cabinet having one or more vertical channels leading to a respective bottom outlet for dispending the packets. The housing has front and rear faces and lateral sides. The channels provide for receiving respective vertical stacks of packets. The channels are adjacently positioned and release their respective bottom outlet is positioned at the front face of the housing releading the packet forwardly.

### OBJECTS

An object of the present disclosure is to provide a dispenser with drawers and silos for small packets.

An object of the present disclosure is to provide a silo drawer dispensing assembly.

An object of the present disclosure is to provide a drawer for a silo drawer dispensing assembly.

An object of the present disclosure is to a provide a silo structure for a silo drawer dispensing assembly.

### SUMMARY

In accordance with an aspect of the present disclosure, there is provided a dispenser for small packets comprising: a housing comprising a cabinet defining a front face thereof and a chute positioned beneath the cabinet for dispensing small packets; at least one pair of drawers slidably mounted within the cabinet and comprising respective front sides positioned at the cabinet front side and respective interfacing lateral dispensing sides defining a common drop channel therebetween leading to the chute, the at least one pair of drawers being slidably movable outwardly and inwardly of the cabinet via the cabinet front face; and at least two silo structures, each of the silo structures being mounted to a respective one of the interfacing dispensing sides and comprising a storage compartment for storing small packets and an ejection device for ejecting the small packets into the drop channel.

In an embodiment, the storage compartment is configured for vertically stacking the small packets therein. In an embodiment, the storage compartment comprises a platform, the vertically stacked small packets being positioned on the platform. In an embodiment, the ejection device is positioned at the platform and provides for ejecting a bottommost small packet of the vertically stacked small packet.

In an embodiment, the dispenser further comprises a plurality of the pairs of drawers, wherein each of the pairs of drawers comprise respective interfacing dispensing sides defining respective common drop channels leading to the chute.

In an embodiment, each of the interfacing dispensing sides comprises a plurality of the silo structures mounted thereto.

In an embodiment, the dispensing side defines a vertical height and horizontal length and provides for a plurality of horizontal rows along the vertical height, each one of the horizontal rows providing for receiving a plurality of the silo structures arranged along the horizontal length of the dispensing side.

In accordance with an aspect of the present disclosure, there is provided a drawer dispensing assembly for a dispenser for small packets comprising a housing comprising a cabinet defining a front face thereof and a chute positioned beneath the cabinet for dispensing small packets, the drawer dispensing assembly comprising: at least one pair of drawers slidably mounted within the cabinet and comprising respective front sides positioned at the cabinet front side and respective interfacing lateral dispensing sides defining a common drop channel therebetween leading the chute, the at one pair of drawers being slidably movable outwardly and inwardly of the cabinet via the cabinet front face; and at least two silo structures, each of the silo structures being mounted to a respective one of the interfacing dispensing sides and comprising a storage compartment for storing small packets and an ejection device for ejecting the small packets into the drop channel.

In an embodiment, the storage compartment is configured for vertically stacking the small packets therein. In an embodiment, the storage compartment comprises a platform, the vertically stacked small packets being positioned on the platform. In an embodiment, the ejection device is positioned at the platform and provides for ejecting a bottommost small packet of the vertically stacked small packet.

In an embodiment, the drawer dispensing assembly further comprises a plurality of the pairs of drawers, wherein each of the pairs of drawers comprise respective interfacing dispensing sides defining respective common drop channels leading to the chute.

In an embodiment, each of the interfacing dispensing sides comprises a plurality of the silo structures mounted thereto.

In an embodiment, the dispensing side defines a vertical height and horizontal length and provides for a plurality of horizontal rows along the vertical height, each one of the horizontal rows providing for receiving a plurality of the silo structures arranged along the horizontal length of the dispensing side.

In accordance with an aspect of the present disclosure, there is provided a dispensing drawer for a dispenser for small packets comprising a housing comprising a cabinet defining a front face thereof and a chute positioned beneath the cabinet for dispensing small packets, the drawer comprising: a main frame body defining top and bottom ends, lateral sides and front and rear faces, wherein the main frame is slidably mounted within the cabinet so as to move inwardly and outwardly thereof with the front face being moved forwardly and rearwardly; at least one of the lateral sides comprises a dispensing side defining a vertical height and horizontal length and providing for a plurality of horizontal rows along the vertical height, each one of the horizontal rows providing for receiving a plurality of silo structures arranged along the horizontal length of the dispensing side, wherein the silo structures comprise a storage compartment for storing small packets and an ejection device for ejecting a small packet from the stack into the cabinet and towards the chute.

In accordance with an aspect of the present disclosure, there is provided a silo structure for being mounted within a dispenser comprising: a storage compartment comprising a platform, a front side and a backing and providing for vertically stacking small packets therein on the platform, the backing being mountable to an inner part of the dispenser, the front side defining a dispensing slot;

and an ejection device positioned at the platform and providing for ejecting a bottommost small packet of the vertically stacked small packet via the dispensing slot.

In an embodiment, the silo structure further comprises a vertical wall adjustably positioned on the platform, wherein the packets are positioned between the front side and the vertical wall, the front side and the vertical wall defining a depth therebetween, wherein the vertical wall is adjustable so as to modify the depth.

In an embodiment, the silo structure further comprises a further comprising a panel positioned at the front side and defining the dispensing slot between a bottom free edge of the panel and the platform, the bottom free edge of the panel and the platform defining a height of the dispensing slot therebetween, wherein the panel is adjustable so as to modify the height of the dispensing slot.

In accordance with an aspect of the present disclosure, there is provided a kit comprising a plurality of the silo structures herein.

In accordance with an aspect of the present disclosure, there is provided a silo drawer dispensing assembly comprising: at least one of the dispensing drawers provided herein and at least one of the silo structures provided herein, wherein the at least one silo structure is mountable to the at least one dispensing drawer.

Other objects, advantages and features of the present disclosure will become more apparent upon reading of the following non-restrictive description of illustrative embodiments thereof, given by way of example only with reference to the accompanying drawings.

### BRIEF DESCRIPTION OF THE DRAWINGS

In the appended drawings:

FIG. 1 is a perspective front and side view of the vertical dispenser in accordance with a non-restrictive illustrative embodiment of the disclosure;

FIG. 2 is a side view of the dispenser of FIG. 1;

FIG. 3 is a front view of the dispenser of FIG. 1;

FIG. 4 is a perspective front and side view of the dispenser of FIG. 1 with open doors exposing the silo drawer dispensing assembly therein in accordance with a non-restrictive illustrative embodiment of the disclosure;

FIG. 5 is front view the dispenser of FIG. 4;

FIG. 6 is a perspective front and side, partially exploded view of the dispenser of FIG. 4 in accordance with a non-restrictive illustrative embodiment of the disclosure;

FIG. 7 is a perspective front and side view of a vertical drawer of the exposed silo drawer dispensing assembly shown in FIG. 4 in accordance with a non-restrictive illustrative embodiment of the disclosure;

FIG. 8 is a perspective rear and side view of the vertical drawer of FIG. 7;

FIGS. 9A is perspective front and side exploded view of the vertical drawer of FIG. 7;

FIG. 9B is a perspective front and side exploded view of a vertical drawer configured for interfacing with the vertical drawer of FIG. 9A in accordance with a non-restrictive illustrative embodiment of the disclosure;

FIG. 10 is a perspective rear and side view of a silo structure for being mounted to the vertical drawer of FIG. 7 in accordance with a non-restrictive illustrative embodiment of the disclosure;

FIG. 11 is a front view of the silo structure of FIG. 10;

FIG. 12 is a side view of the silo structure of FIG. 10;

FIG. 13 is an enlarged view of portion 13 in FIG. 12;

FIG. 14 is a rear view of the silo structure of FIG. 10;

FIG. 15 is a perspective front and side exploded view of the silo structure of FIG. 10 accordance with a non-restrictive illustrative embodiment of the disclosure;

FIG. 16 is a perspective front a side view of the dispensing base of the silo structure of FIG. 10;

FIG. 17 is a side partial view of a lower part of the silo structure of FIG. 10 showing the dispensing base of FIG. 16; and

FIG. 18 is a perspective front and side view of the vertical drawer of

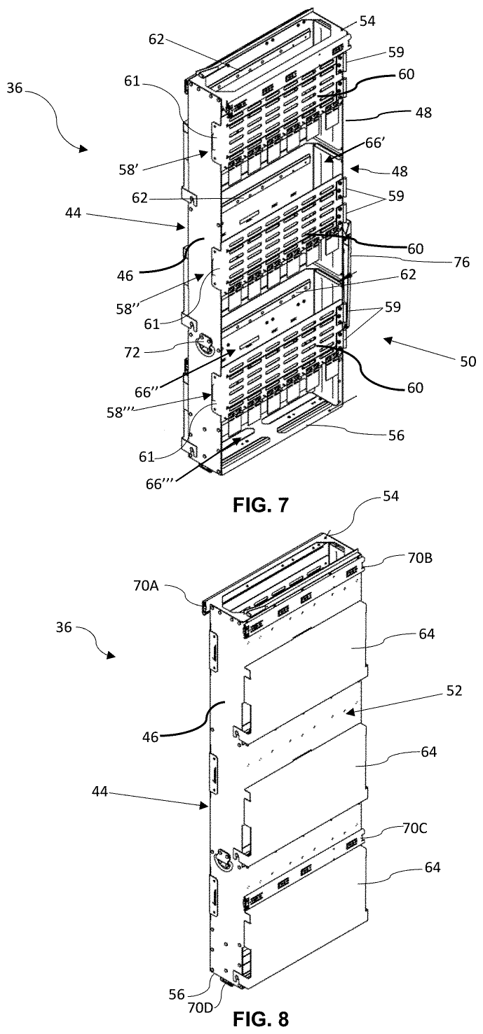

FIG. 7 including multiple silo structures therein.

### DETAILED DESCRIPTION OF ILLUSTRATIVE EMBODIMENTS

Generally stated and in accordance with an aspect of the present disclosure, there is provided a dispenser for small packets comprising a housing having a cabinet and a chute positioned beneath the cabinet for dispensing small packets. At least one pair of drawers is slidably mounted within the cabinet. Each of these drawers has respective front sides positioned at the cabinet front side and respective interfacing lateral dispensing sides defining a common drop channel therebetween leading the chute. The drawers are slidably movable outwardly and inwardly of the cabinet via the cabinet front face. Each of the interfacing lateral dispensing sides has at least one silo structure mounted thereof. Each silo structure comprises a storage compartment for storing small packets and an ejection device for ejecting the small packets into the drop channel.

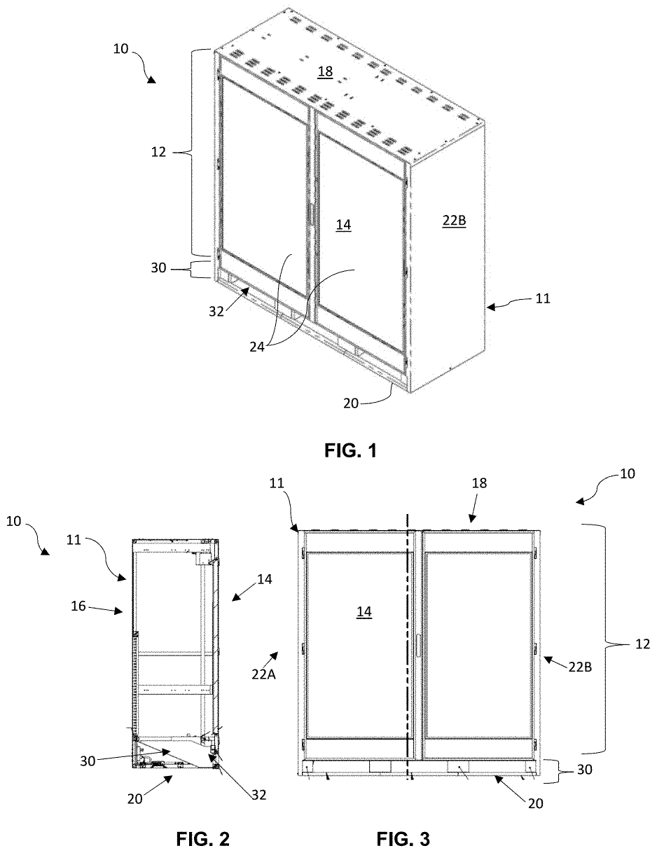

With reference to FIGS. 1 to 3, there is shown a dispenser 10 comprising a housing 11 comprising a cabinet 12. The housing 11 defines front and rear sides, 14 and 16 respectively, top and bottom ends, 18 and 20, respectively and lateral sides 22A and 22B. The cabinet 12 includes doors 24 at its front side 14. The doors 24 are hinged to the cabinet 12 via hinges 26. The doors 24 can provide for digital signage on their front surfaces 28. The housing 11 comprises a chute section 30 positioned beneath the cabinet 12 at the bottom end 20 defining a slot opening 32 for dispensing the packets.

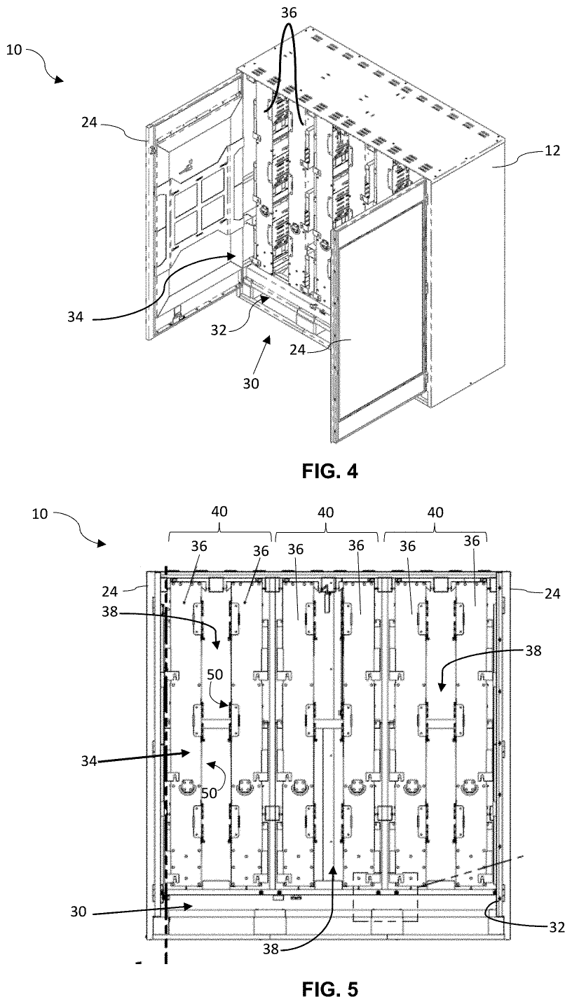

With reference to FIGS. 4 to 6, the dispenser 10 comprises a silo drawer dispensing assembly 34 positioned within the cabinet 12 and accessible when opening the doors 24. The assembly 34 includes pairs of interfacing vertical drawers 36 spaced apart to form a dispensing or drop channel 38 therebetween. In this example, there are six drawers 36, each pair 40 of interfacing drawers 36 forms a respective channel 38 therebetween thereby providing three such channels 38. Each drop channel 38 leads to a respective chute slide 42 at the chute section 30 for allowing the packet to slide to the opening 32 for dispensing thereof. Each of the drawers 36 is outwardly slidable for replenishing with packets and inwardly slidable to be put back to use. The three chute slides 42 shown are secured to a rear elongated backing 43 and an elongated front outlet structure 41.

The doors 24 include respective inner structures 45 mounted to the peripheral frame 25 which is closed by the outer panel 23 of the door 24. The inner structure 45 provide for supporting cables required for the purposes herein. In an embodiment, panel 23 is the digital signage display.

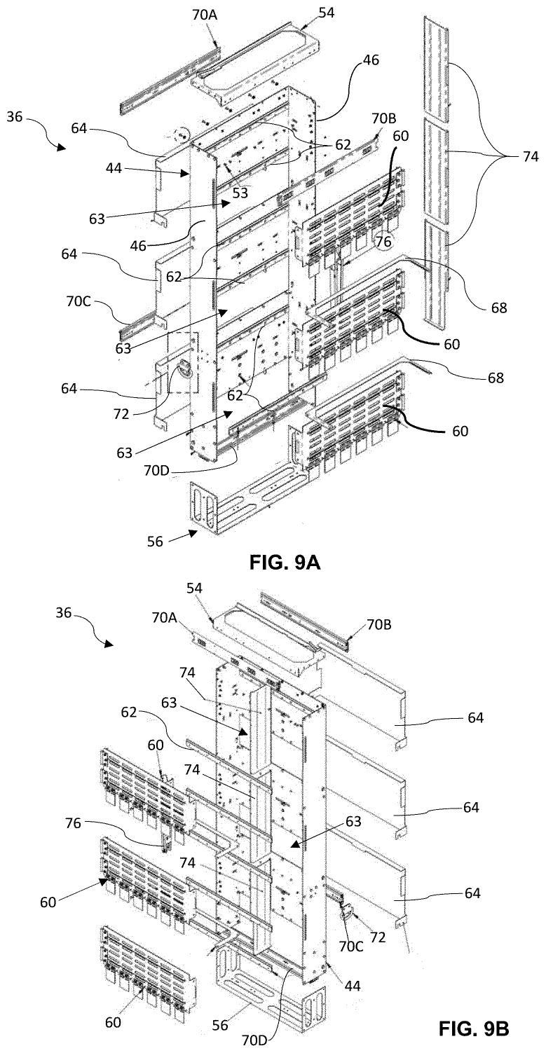

Turning to FIGS. 7, 8, 9A and 9B, there is shown a vertical drawer 36 comprising having a main frame 44 defining front and rear walls 46 and 48 respectively, an open silo receiving side 50 and an opposite silo support wall 52, and top and bottom end plates 54 and 56 respectively. Indeed, two interfacing drawers 36 such as the pair of drawers shown in FIGS. 7 and 8 or the pairs of drawers shown in FIGS. 9A and 9B, sharing the same drop channel 38 have their silo receiving sides 50 interfacing, as shown in FIG. 5.

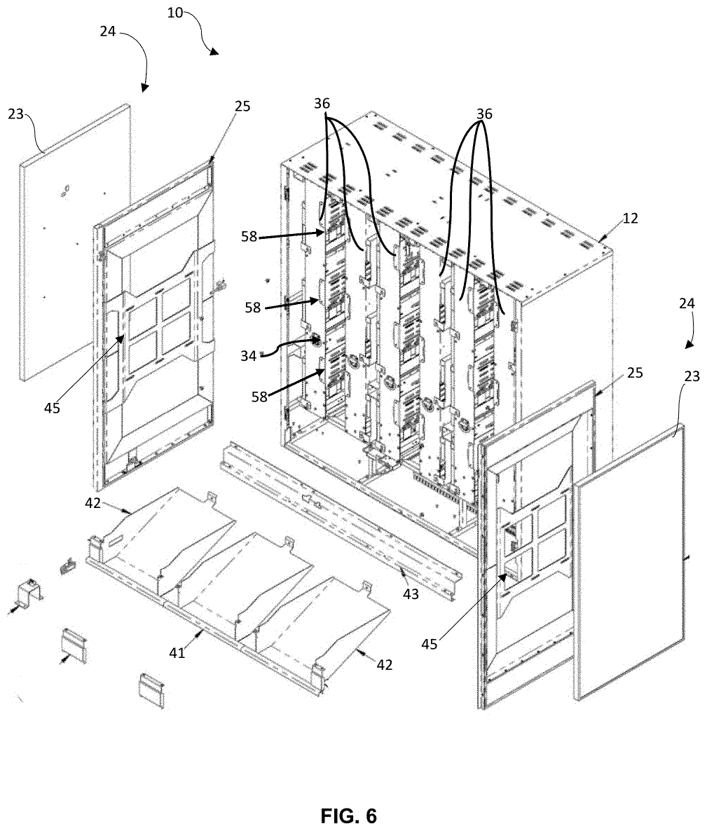

With brief reference to FIG. 6, a drawer 36 defines a plurality of silo support rows 58. In this example and as better shown in FIG. 7, a drawer 36 has three support rows 58, namely a top row 58′, a middle row 58″ and a bottom row 58′″. Each support row 58 includes a door panel 60 hinged (via hingers 59) at one lateral end thereof to the main frame body 44 at its rear wall 48 and releasable locked (via flange 61) at the other end thereof to main frame body 44 at its front wall 46. In this way, the door panel 60 can be selectively opened and closed for adding, removing silo structures further discussed below or stacking packets in these silo structures. Each row 58 also includes clip rails 62 on the inner side 53 of the support wall 52 extending between the walls 46 and 48 for receiving the silo structures provided herein. The support wall 52 defines openings 63 which are closed by removable covers 64 that allow for accessing wiring and cables further discussed herein. The rows 58′, 58″ and 58′″ are spaced part defining open spaces 66′ and 66″ with respective bracket-shaped drawer support caps 68 positioned therein and mounted along the inner sides of walls 46, 52 and 48.

A cap 68 is positioned between each row of silos and provides structural integrity to the drawer main frame body 44. The location of cap 68 in this three-row drawer example represents the breakpoints where the body 44 would be shortened and end plate 56 would replace cap 68 in a two row or single row version of drawer.

A drawer sliding system provides for sliding a drawer 36 outwardly and inwardly of the cabinet 12. The drawer sliding system includes a pair of parallel and opposite top slides 70A and 70B mounted to the top plate 54 at sides 50 and 52, respectively, of the main frame 44; a middle slide 70C mounted to side 52 near bottom row 58′″ and a bottom slide 70D positioned underneath the drawer 36 connected to the bottom plate 56. The front wall 46 includes a pull handle 72 allowing a user to slide the drawer 36 outwardly and inwardly of cabinet 12. The foregoing is but one non-limiting embodiment, and as such, a variety of suitable drawer sliding systems can be contemplated within the scope of the present disclosure.

Internal wall elements 74 provide for fixing the silos structure thereto.

An internal wall element 74 acts as a fourth wall for the last silo in each row (i.e., silo located to the far right of each row). Since the silo body has an open side, it uses the outside wall of the adjacent silo (to its right) as a fourth wall. The internal wall element acts as a cover closing the open side of the last silo and without this extra cover for the last silo, the packet product would not be adjacent to a smooth surface but rather with mounting hardware.

The rear wall 46 of the main frame 44 includes a cable arm 76 allowing the various required cables of the dispenser 10 to follow the outward/inward sliding movement of the drawer 36 without squeezing the cables. The arm 76 is mounted at one end to the rear wall of the main frame 44 at the other end thereof to the inner part of the rear side wall 16 of cabinet 12.

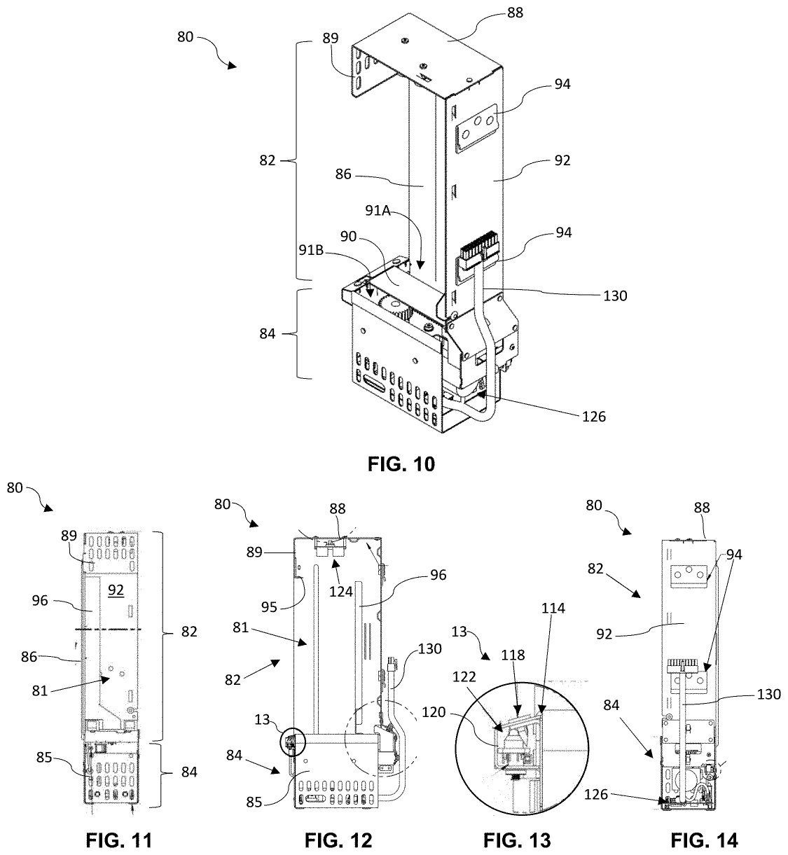

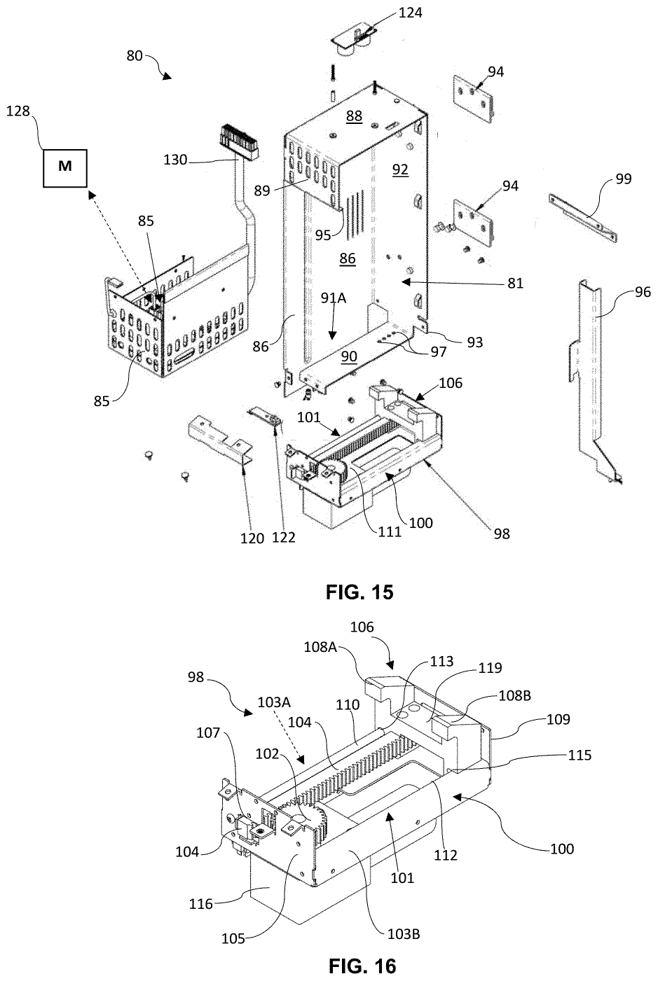

With reference to FIGS. 10 to 15, the silo structures 80 of the dispenser 10 will now be described in accordance with a non-limiting illustrative embodiment of the present disclosure.

The silo structure 80 includes a top storage compartment 82 mounted to and upstanding from a bottom section 84.

The top storage compartment 82 includes a lateral side panel 86 and a bottom platform 90 spaced apart from the side panel 86. A rear panel 92 extends from the bottom platform 90 and is adjoined to the lateral panel 86 forming a right angle therewith. A top panel 88 is positioned at the top ends of the side panel 86 and rear panel 90. A short front panel 89 hangs from the top panel 88. The front side of the compartment 82 opposite rear panel 92 is open. The lateral side of the compartment 82 opposite the lateral side panel 86 is open. The open sides of compartment 82 expose an inner silo space 81 for vertically stacking small packets therein on the bottom platform panel 90. The rear panel 92 includes clip mounts 94 for being mounted to the clip rails 62 in the drawers 36. A vertical back holder 96 is mountable to the platform 90 at different mounting positions 97 to adjust the depth of the silo space 81. The platform 90 is a tongue-like element. The tongue-like shaped platform 90 is spaced apart from the lateral side panel 86 and inwardly recessed relative to the outer edge 93 of the rear panel 92 it extends from. The foregoing configuration of the platform 90 provides lateral spaces 91A and 91B on each side thereof which will be further discussed below. The short front panel 89 has an inward tab 95 extending into the silo space 81 and acting as a stopper to provide a maximum packet fill line.

The bottom section 84 comprises a base shell 85 with an ejection device 98 nested therein.

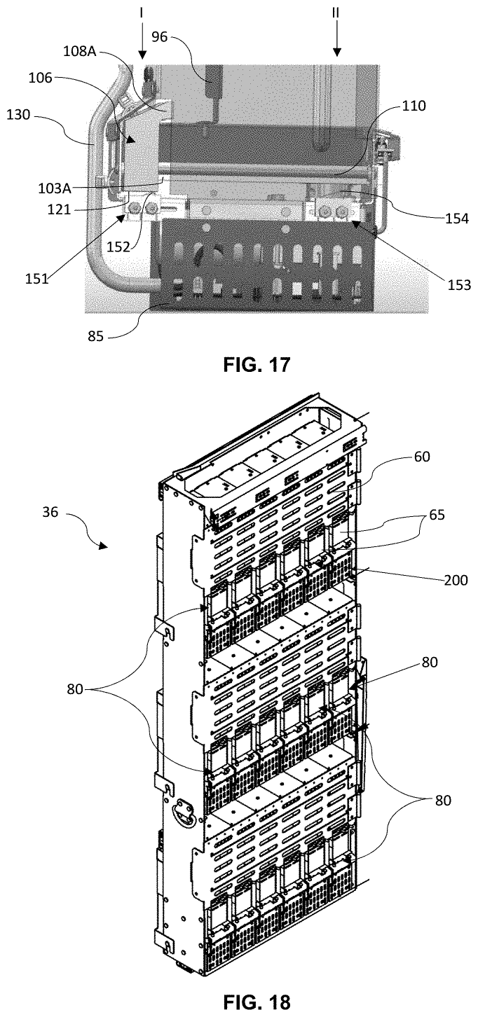

The ejection device 98 comprises an outer support body 100 for supporting therein an actuator and packet pushing assembly 101 for forwardly pushing a packet to be dispensed from the storage compartment 82 into the drop channel 30. The outer support body has a rectangular configuration defining opposite lateral walls 103A (see FIGS. 17) and 103B, front and rear walls 105 and 109, respectively, and inner support platforms 111. The rear wall 109 is connected to panel 92 via bracket 99.

The actuator and packet pushing assembly 101 comprises a pinion gear 102 acting on a movable rack 104 positioned near lateral wall 103A, spaced above support platforms 111 and connected to a pusher 106 for imparting a forward and rearward movement thereto. The pusher 106 comprises a pair of upwardly extending push fingers 108A and 108B which are respectively positioned in the lateral spaces 91A and 91B so as to engage the bottommost packet thereon.

When the pinion gear 102 is actuated to rotate in one direction (a “first” direction) it acts on the rack 104 to move it forwardly out of aperture 107 formed in the front wall 105 the support body 100. As the rack 104 is moved forwardly it pulls the pusher 106 along with it (forward direction). The support body 100 has a guide shaft 110 at wall 103A and defines a free edge 112 at wall 103B. The pusher 106 has a bottom edge slot 113 so as to slide along the guide shaft 110 and bottom recess 115 to slide above or on edge 112 providing for the fingers 108A and 108B to forwardly push the bottommost packet forwardly along the platform 90 pushing it off the front edge 114 thereof into the drop channel 38. The pusher 106 includes a bridge 119 interconnecting the two fingers 108A and 108B and being positioned beneath platform 90.

When a packet has been pushed off the platform 90, the stack of packets drops down onto the platform and the next upper packet becomes the bottommost packet. When the pinion gear 102 is actuated to rotate in another direction (a “second” direction) it imparts an opposite movement on the rack 104 causing it to move inwardly and to bring back the pusher 106 (rearward direction) to its original position as it slides along the shaft 110 and the edge 112 (or above the edge 112). Pusher 106 has an angle on the back faces of 108A and 108b. This angle ensures the lowest point of that surface fall bellow surface 90. This ensure on the backward movement that the new bottom pack does not get squeezed but rather being pushed upwards. When the pusher 106 is back in the fully retracted position, the bottom pack can rest flat on surface 90 and be ready to be dispensed on the next command. The pinion gear 102 is operatively connected to an actuator 116, such as a motor positioned beneath the outer body 100 for imparting thereto the rotational movements discussed hereinabove.

Turning to FIG. 17, as the pusher 106 moves from the fully retracted position I to the fully forward position II it moves along a linear pathway from electrical limit switch 151 to electrical limit switch 153. When the actuator 116 actuates the pusher 106 to move in this forward direction from the retracted position I the bottom end 121 of the pusher 106 engages the flexible tab 154 of limit switch 153 and depresses the tab 154 at position II thereby sending an electrical signal indicating that position II has been reached thereby causing the actuator 116 to stop actuating the pinion gear 102 to rotate in the “first” direction. When the pusher 106 moves from position II back to position I along the linear pathway (i.e. in the rearward direction), the bottom end 121 of the pusher 106 eventually engages the flexible tab 152 of the limit switch 151 and depresses the tab 152 at position I thereby sending an electrical signal indicating that position I has been reached thereby causing the actuator 116 to stop actuating the pinion gear to rotate in the “second” direction.

With reference to FIG. 13, a front sloped part 118 is mounted to the front platform edge 114 for products to slide along part 118 when pushed into the channel 38. Part 118 defines a casing 120 containing a sensor 122 which detects whether or not the packet has actually been fully dispensed from the platform 90.

In an embodiment, sensor 122 comprises an infrared sensor. Of course, other suitable sensors and positionings can be contemplated within the scope of the present disclosure.

As shown in FIG. 12, a sensor 124 is mounted to the top panel 88 to detect the height of the vertically stacked packets within the space 81 thereby detecting the amount of product within the silo structure 80. Sensor 124 can be an ultrasonic sensor, a TOF sensor, a Long-Range sensor, or any other type of suitable sensor for detecting the amount of packet inventory within the silo structure 81.

In an embodiment, the base shell 85 comprises a controller 126 (shown in FIG. 14) therein, such as a PCB for example, in operative communication with the actuator 116 for control and modulation thereof. In an embodiment, the controller 126 also manages the signals from the limit switches 151 and 153. In an embodiment, the controller 126 is in operative communication with the sensors 122 and/or 124 via wire or wireless communication. In an embodiment, the controller 126 is in operative communication with a master controller 128 via wireless communication or via wired communication by of cables 130 for example. In an embodiment, the sensors 122 and 124 are in wire or wireless operative communication with the master controller 128.

Of course, the skilled artisan can contemplate a variety of cable, wireless architectures between master controllers (processors) and slave controllers (microprocessors, PCB and the like) in operative communication with the actuator 116 and the sensor 122 and 124 in order for a user to request, via a user interface, the dispensing of particular packets found in particular silo structures 80 of within the dispenser 10 and for the computer-implemented system provided herein to allow the dispensing thereof, to ascertain whether the packet has been actually dispensed from its silo structure 80 and to determine the inventory within each silo structure 80. Moreover, the master controller 128 may be programed to not allow two interfacing silo structures 80 of two interfacing drawers 36 sharing the same drop channel to dispense packets in tandem as this may block the operation if the packets of each silo structure 80 mutually interfere with each other. Indeed, the master controllers may be in operative communication with a remote server feeding the foregoing date thereto in order to allow inventory management of a plurality of dispensers at a plurality of locations, thus, allowing various inventory and dispensing data to be communicated to central management via the server and to store management personnel via the master controller and user interface.

The silo structure depth, width, and height are adjustable. Various numbers of silos, including various sizes thereof of various widths thereof can be positioned within a given drawer row compartment of the drawer 36 providing the user with the possibility to modulate inventory amount and size as needed.

The interfacing nature of the drawers sharing a common drop channel provides for increasing the number of silos and packets fitted into the dispenser 10 as per user requirements without requiring increasing the size of the cabinet 14.

In an embodiment the drawers are provided with an anti-tilt system. As the dispenser 10 is top heavy, a mechanical device is incorporated that will lock in place all drawers except the one being pulled out. When the drawer is pushed back in, the system resets itself allowing any drawer to again be pulled out.

In an embodiment, the doors have 180 degree hinges with an offset rotation point. This allows multiple dispenser machines installed side by side and keep a full 180 door opening on either machine. It can also allow the machine to be installed against a wall or event recessed into the wall construction.

In an embodiment, the frame structure of the dispenser provides for a a version that would be filled from the back. The required modifications are to reverse the drawer slides, replace the back panels by a set of doors, and mount the signage display on a static frame instead of a hinged door. The advantage of a back fill option is for end user to install the machine recessed into a wall separating front and back store areas. The reloading operations happening from the back store prevent customers from potentially seeing large volumes of products that they could normally see during the restocking of a front-loading unit.

Turning now to FIG. 18, the vertical drawer 36 is shown with multiple silo structures 80 positioned therein. As shown, each silo defines a dispensing slot 200 for packets to be dispensed from as provided herein. The size of the dispensing slot 200 is adjustable by adjusting the size or the position of the front flap 65 mounted to the door panel 60. The flap 65 hangs from the door panel 60 and partially covers the front open side of compartment 82 and leaving a slot 200 defined between the bottom edge of the panel 64 and the platform 90.

The various features described herein can be combined in a variety of ways within the context of the present disclosure so as to provide still other embodiments. As such, the embodiments are not mutually exclusive. Moreover, the embodiments discussed herein need not include all of the features and elements illustrated and/or described and thus partial combinations of features can also be contemplated. Furthermore, embodiments with less features than those described can also be contemplated. It is to be understood that the present disclosure is not limited in its application to the details of construction and parts illustrated in the accompanying drawings and described hereinabove. The disclosure is capable of other embodiments and of being practiced in various ways. It is also to be understood that the phraseology or terminology used herein is for the purpose of description and not limitation. Hence, although the present disclosure has been provided hereinabove by way of non-restrictive illustrative embodiments thereof, it can be modified, without departing from the scope, spirit and nature thereof and of the appended claims.

1. A dispenser for small packets comprising:
a housing comprising a cabinet defining a front face thereof and a chute positioned beneath the cabinet for dispensing small packets;
at least one pair of drawers slidably mounted within the cabinet and comprising respective front sides positioned at the cabinet front side and respective interfacing lateral dispensing sides defining a common drop channel therebetween leading to the chute, the at least one pair of drawers being slidably movable outwardly and inwardly of the cabinet via the cabinet front face; and
at least two silo structures, each of the silo structures being mounted to a respective one of the interfacing dispensing sides and comprising a storage compartment for storing small packets and an ejection device for ejecting the small packets into the drop channel.

2. A dispenser according to claim 1, wherein the storage compartment is configured for vertically stacking the small packets therein.

3. A dispenser according to claim 2, wherein the storage compartment comprises a platform, the vertically stacked small packets being positioned on the platform.

4. A dispenser according to claim 3, wherein the ejection device is positioned at the platform and provides for ejecting a bottommost small packet of the vertically stacked small packet.

5. A dispenser according to claim 1, further comprising a plurality of the pairs of drawers, wherein each of the pairs of drawers comprise respective interfacing dispensing sides defining respective common drop channels leading to the chute.

6. A dispenser according to claim 1, wherein each of the interfacing dispensing sides comprises a plurality of the silo structures mounted thereto.

7. A dispenser according to claim 1, wherein the dispensing side defines a vertical height and horizontal length and provides for a plurality of horizontal rows along the vertical height, each one of the horizontal rows providing for receiving a plurality of the silo structures arranged along the horizontal length of the dispensing side.

8. A drawer dispensing assembly for a dispenser for small packets comprising a housing comprising a cabinet defining a front face thereof and a chute positioned beneath the cabinet for dispensing small packets, the drawer dispensing assembly comprising:
at least one pair of drawers slidably mounted within the cabinet and comprising respective front sides positioned at the cabinet front side and respective interfacing lateral dispensing sides defining a common drop channel therebetween leading the chute, the at one pair of drawers being slidably movable outwardly and inwardly of the cabinet via the cabinet front face; and
at least two silo structures, each of the silo structures being mounted to a respective one of the interfacing dispensing sides and comprising a storage compartment for storing small packets and an ejection device for ejecting the small packets into the drop channel.

9. A drawer dispensing assembly according to claim 8, wherein the storage compartment is configured for vertically stacking the small packets therein.

10. A drawer dispensing assembly according to claim 9, wherein the storage compartment comprises a platform, the vertically stacked small packets being positioned on the platform.

11. A drawer dispensing assembly according to claim 10, wherein the ejection device is positioned at the platform and provides for ejecting a bottommost small packet of the vertically stacked small packet.

12. A drawer dispensing assembly according to claim 8, further comprising a plurality of the pairs of drawers, wherein each of the pairs of drawers comprise respective interfacing dispensing sides defining respective common drop channels leading to the chute.

13. A drawer dispensing assembly according to claim 8, wherein each of the interfacing dispensing sides comprises a plurality of the silo structures mounted thereto.

14. A drawer dispensing assembly according to claim 8, wherein the dispensing side defines a vertical height and horizontal length and provides for a plurality of horizontal rows along the vertical height, each one of the horizontal rows providing for receiving a plurality of the silo structures arranged along the horizontal length of the dispensing side.

15. A dispensing drawer for a dispenser for small packets comprising a housing comprising a cabinet defining a front face thereof and a chute positioned beneath the cabinet for dispensing small packets, the drawer comprising:
a main frame body defining top and bottom ends, lateral sides and front and rear faces, wherein the main frame is slidably mounted within the cabinet so as to move inwardly and outwardly thereof with the front face being moved forwardly and rearwardly;
at least one of the lateral sides comprises a dispensing side defining a vertical height and horizontal length and providing for a plurality of horizontal rows along the vertical height, each one of the horizontal rows providing for receiving a plurality of silo structures arranged along the horizontal length of the dispensing side, wherein the silo structures comprise a storage compartment for storing small packets and an ejection device for ejecting a small packet from the stack into the cabinet and towards the chute.

16. A silo structure for being mounted within a dispenser comprising:
a storage compartment comprising a platform, a front side and a backing and providing for vertically stacking small packets therein on the platform, the backing being mountable to an inner part of the dispenser, the front side defining a dispensing slot; and
an ejection device positioned at the platform and providing for ejecting a bottommost small packet of the vertically stacked small packet via the dispensing slot.

17. A silo structure according to claim 16, further comprising a vertical wall adjustably positioned on the platform, wherein the packets are positioned between the front side and the vertical wall, the front side and the vertical wall defining a depth therebetween, wherein the vertical wall is adjustable so as to modify the depth.

18. A silo structure according to claim 16, further comprising a panel positioned at the front side and defining the dispensing slot between a bottom free edge of the panel and the platform, the bottom free edge of the panel and the platform defining a height of the dispensing slot therebetween, wherein the panel is adjustable so as to modify the height of the dispensing slot.
